(19) United States
(12) Patent Application Publication
(10) Pub. No.: US 2010/0165109 A1
(43) Pub. Date: Jul. 1, 2010

(54) Method and system for automatic monitoring of portable image capturing apparatus

(76) Inventor: I-Lung Lang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,465

(22) Filed: Oct. 16, 2009

(30) Foreign Application Priority Data
Dec. 26, 2008 (TW) 97150839

(51) Int. Cl. H04N 7/18

(52) U.S. Cl. 348/158; 348/E07.085

(57) ABSTRACT

A method and a system for automatic monitoring made by a portable image-capturing apparatus are disclosed. The apparatus includes an image-capturing module, an image variation detecting module, and an automatic video recording module. The method preferably uses the image variation detecting module to determine whether or not a variation event occurs in a predetermined region. And the automatic video recording module records a video in the predetermined region according to the determination result. If the determination result is positive, the automatic video recording module then starts video recording. Next, if the variation event disappears for a period of time, the automatic video recording module stops recording the video.

### BACKGROUND OF THE INVENTION

1. Field of the Invention

The present invention relates to a method and a system for automatic monitoring, especially to a method and a system for automatic monitoring used for portable image capturing apparatus.

2. Description of the Related Art

Generally, the monitoring devices are set up everywhere on the street and even in the house, in order to record the possible criminal events.

However, a whole set of monitoring device costs lots of money and may not be affordable for everyone. Generally speaking, a common user does not need to observe everyday, but only needs to activate the monitoring set when he travels outdoors, leaves children at home, or watches valuable belongings. It actually wastes resources for common user to buy a whole set of monitoring device when he merely uses on those occasional events.

Further, when the monitoring device works without any operator, it operates video recording continuously for monitoring purpose. Even today, incorporates with the digitalized monitoring devices, users still needs to prepare a big amount of storage memory for the video recording. And even the monitoring devices did capture the crime, it's not convenient to find the critical scene among the video.

Since the monitoring equipment is too heavy to be carried, the user needs to prepare a portable pinhole camera or any surveillance apparatus additionally if he needs to monitor something while travels.

Besides to guard against burglary, the video monitoring is also applicable to wild animal observation or experiment observation. When those activities require the use of the surveillance equipments, the problems described above still occur.

Therefore, how to use a simpler monitoring equipment to solve these problems such as high cost, using inconvenience, and incapable of carrying, is an important topic nowadays.

### SUMMARY OF THE INVENTION

The present invention describes a method and system for automatic monitoring of portable image capturing apparatus. By using the ordinary portable image capturing apparatus for monitoring, the purposes of reducing the cost of video monitoring, increasing the convenience of carrying the monitoring equipment, decreasing the memory usage of storing monitoring video, and decreasing unnecessary video recording can be achieved. Further, it makes the user easier to review the monitoring video. Thus, the convenience, application fields, and practical value of video monitoring are increased according to the present invention.

In order to achieve the aforementioned objects, according to a scheme of the present invention, a system for automatic monitoring of portable image capturing apparatus is provided. The system is applicable to video monitoring in a predetermined region. The apparatus includes an image capturing module and an automatic monitoring system, in which the image capturing module further includes an optical image capturing component and an image sensor such as charge coupled device (CCD). The optical image capturing component is for monitoring the predetermined region continuously, and sending the images to the image sensor.

The automatic monitoring system includes an image variation detecting module, which is coupled with the image sensor. The image variation detecting module is used for detecting a variation event occurring in the predetermined region. The system further includes an automatic video recording module, which is coupled with the image sensor and the image variation detecting module. The automatic video recording module is used for automatic video recording when the image variation detecting module detects the variation event occurring in the predetermined region.

Furthermore, the image variation detecting module includes a motion detecting module for detecting an event of object moving, and further has a character recognizing module for determining whether the variation event is a person allowed to enter the predetermined region or not. When the image variation detecting module detects an object moving event or a suspicious person, the automatic video recording module then starts to record the video of the predetermined region. If the variation event disappears for a period of time, the automatic video recording module stops the video recording and stores the monitoring video in a memory unit.

According to another scheme of the present invention, a method for automatic monitoring of portable image capturing apparatus is provided. The method is applicable to a portable image capturing apparatus which includes at least an image capturing module. The method includes a step of capturing a plurality of images of a predetermined region continuously with the image capturing module. Further, a step of determining whether or not a variation event occurs in the predetermined region according to the images is included. Next, a step of recording a monitoring video of the predetermined region if the variation event does occur in the predetermined region. Furthermore, if the variation event disappears for a period of time, the recording of the monitoring video stops.

The portable image apparatus determines whether or not a variation event occurs in the predetermined region. If the variation event occurs, it starts to record the monitoring video, and if the variation event disappears for a period of time, it stops the monitoring video recording.

By using the portable image apparatus for monitoring, the cost of video monitoring decreases. Moreover, it's convenient to carry and operate. Additionally, the automatic monitoring method makes the monitoring video not too long, and decreases the memory usage. Therefore, it's much more convenient for users to review the monitoring video. Furthermore, the application fields and the practical value of video monitoring increase.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a block diagram of an embodiment of a portable image capturing apparatus according to the present invention;

FIG. 2 and FIG. 3 are device diagrams of an embodiment of a portable image capturing apparatus according to the present invention;

FIG. 4 is a flow chart of a method of an embodiment for automatic monitoring of portable image capturing apparatus according to the present invention; and

FIG. 5 is a flow chart of a method of another embodiment for automatic monitoring of portable image capturing apparatus according to the present invention.

### DETAILED DESCRIPTION OF THE PREFERRED EMBODIMENTS

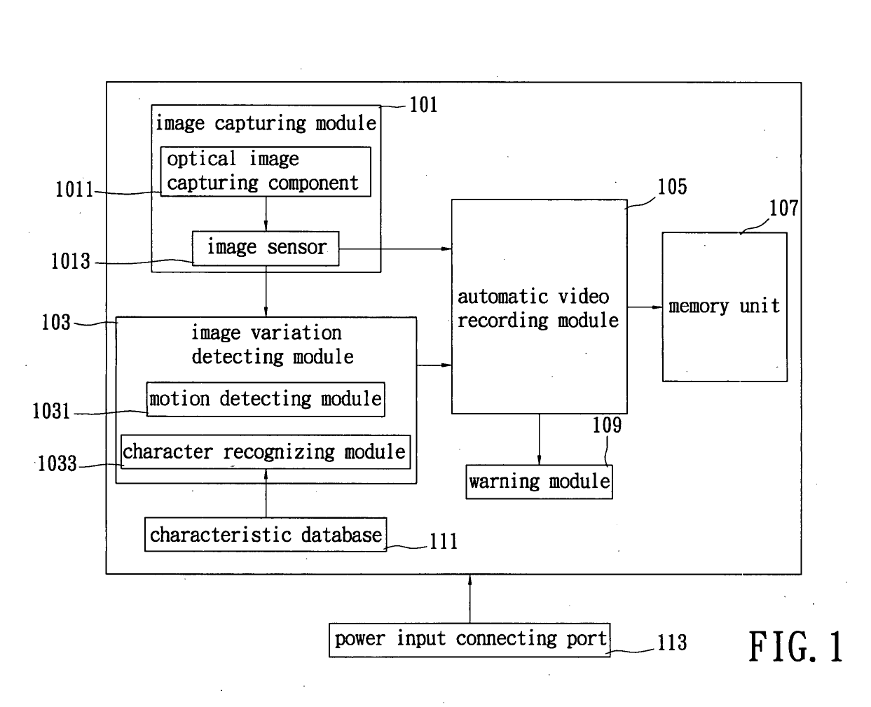

Refer to FIG. 1, which is a block diagram of an embodiment of portable image capturing apparatus with automatic monitoring capability. The apparatus can be a digital camera, a video recording device in mobile phone, a digital video recorder, or other devices capable of taking pictures and recording video. The apparatus is applicable to a predetermined region monitoring, including an image capturing module 101, which includes an optical image capturing component 1011 and an image sensor 1013 (such as a CCD). The optical image capturing component 1011 is used to continuously capture images in the predetermined region and sending the images to the image sensor 1013 The apparatus further includes an image variation detecting module 103 coupled with the image sensor 1013, in which the module 103 is for detecting whether or not a variation event occurs in the predetermined region; and an automatic video recording module 105 which is coupled with the image sensor 1013 and the image variation detecting module 103. The automatic video recording module 105 is for automatically recording the monitoring video of the predetermined region if the image variation detecting module 103 detects at least one variation event.

Furthermore, the portable image capturing apparatus includes a memory unit 107 which is coupled with the automatic video recording module 105, in which the memory unit 107 is for storing the monitoring video. And the apparatus has a power input connecting port 113 for connecting external power supply circuits and inputting electrical power to the apparatus. The apparatus further has a warning module 109, coupled with the automatic video recording module 105, in which the warning module 109 is used for connecting an external network and sending a warning signal to a decided electronic device. For example, the warning signal can be a warning message sent to a desired mobile phone. More, the warning signal can also be an email sent to a computer or personal digital assistant (PDA) over an external network.

Additionally, the image variation detecting module 103 includes a motion detecting module 1031 used for detecting object moving. The module 103 further has a character recognizing module 1033 used for determining whether a suspicious person coming into the predetermined region according to the characteristic data stored in a characteristic database 111. In which the external network that the warning module 109 connects with can be a wired network or a wireless network.

When the portable image capturing apparatus enters an automatic monitoring mode, the image capturing module 101 continuously captures the images of the predetermined region and sends the images to the image sensor 1013. Next, the image variation detecting module 103 determines whether or not at least one variation event occurs in the predetermined region according to the images. If the variation events occur, then the apparatus starts to record a monitoring video of the predetermined region, and sends the warning signals to the decided electronic device through the warning module 109. Additionally, if the variation event disappears for a period of time, the apparatus then stops the monitoring video recording and stores the monitoring video in the memory unit 107. Wherein the image variation detecting module 103 and the automatic video recording module 105 are parts of the system for automatic monitoring of the portable image capturing apparatus.

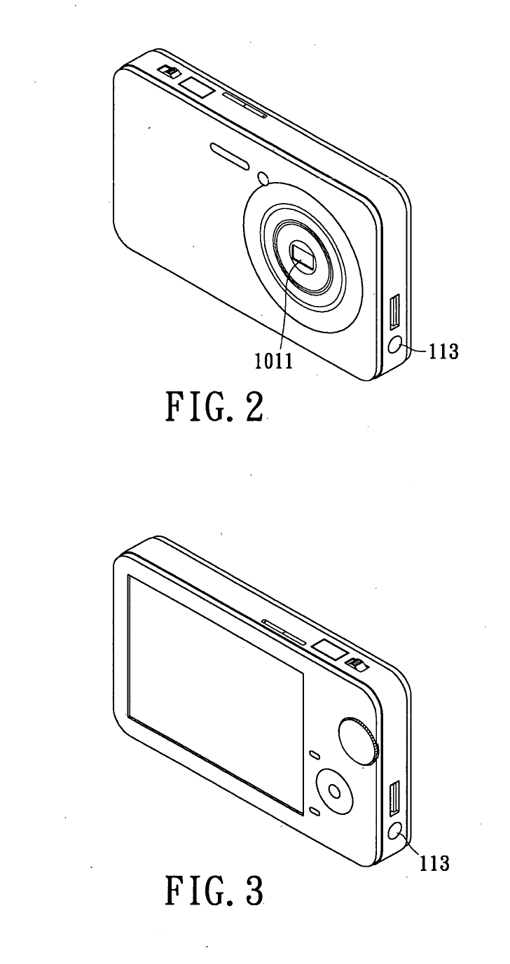

Referring to FIG. 2 and FIG. 3, which show the block diagrams of an embodiment of portable image capturing apparatus with automatic monitoring capability. In conjunction with FIG. 1, the embodiment is a digital camera, which comprises an optical image capturing component 1011, for continuously capturing a plurality of images of a predetermined region; and a power input connecting port 113, for connecting outward power supply circuits and providing the needed electrical power to the digital camera.

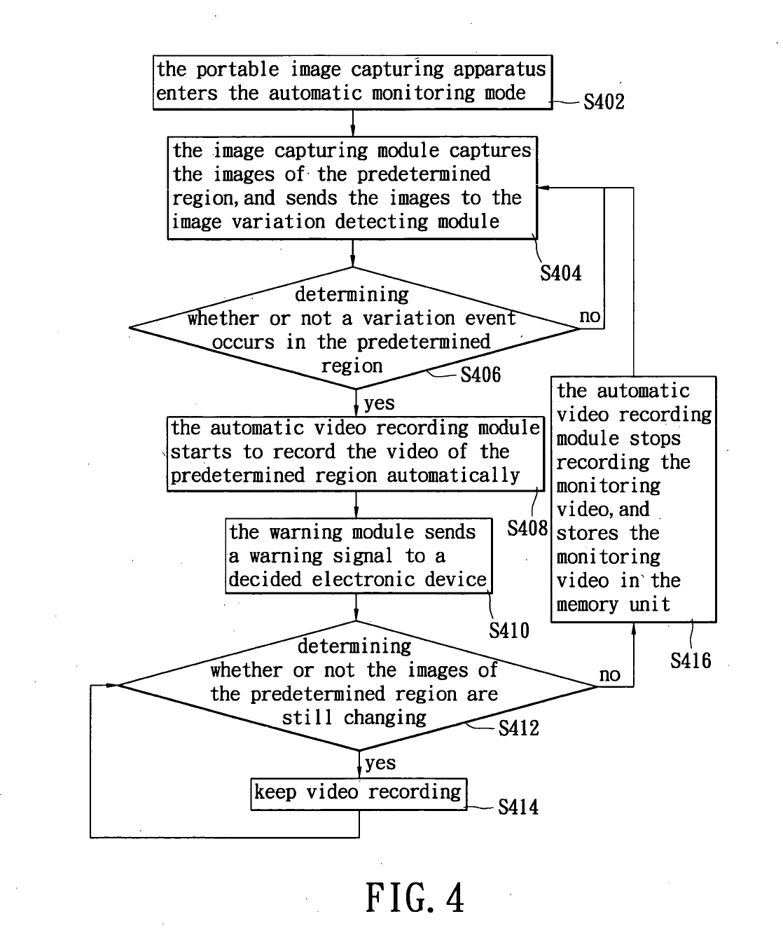

Refer to FIG. 4, which is a flow chart of an embodiment of a method for automatic monitoring of portable image capturing apparatus. In conjunction with FIG. 1, the method includes: the portable image capturing apparatus enters an automatic monitoring mode (S402). Next, the image capturing module 101 captures a plurality of images of the predetermined region and sends the images to image variation detecting module 103 (S404) for further determination.

The image variation detecting module 103 then determines whether or not a variation event occurs in the predetermined region (S406). If the determination result is negative, go back to step S404 for capturing the images of the predetermined region continuously; and if the determination result is positive, the automatic video monitoring module 105 of the portable image capturing apparatus starts to record a monitoring video of the predetermined region (S408). When the monitoring video is recording, the warning module 109 sends a warning signal to a decided electronic device (S410), such as a mobile phone or a computer.

Furthermore, the image variation detecting module 103 continuously determines whether the images of the predetermined region are still changing (that is, the variation event is still occurring) (S412). If the variation event is still occurring, then keep recoding the monitoring video (S414); and if the variation event disappears for a period of time, the automatic video recording module 105 then stops the monitoring video recording and stores the monitoring video in the memory unit 107 (S416), to achieve the purpose of automatic monitoring.

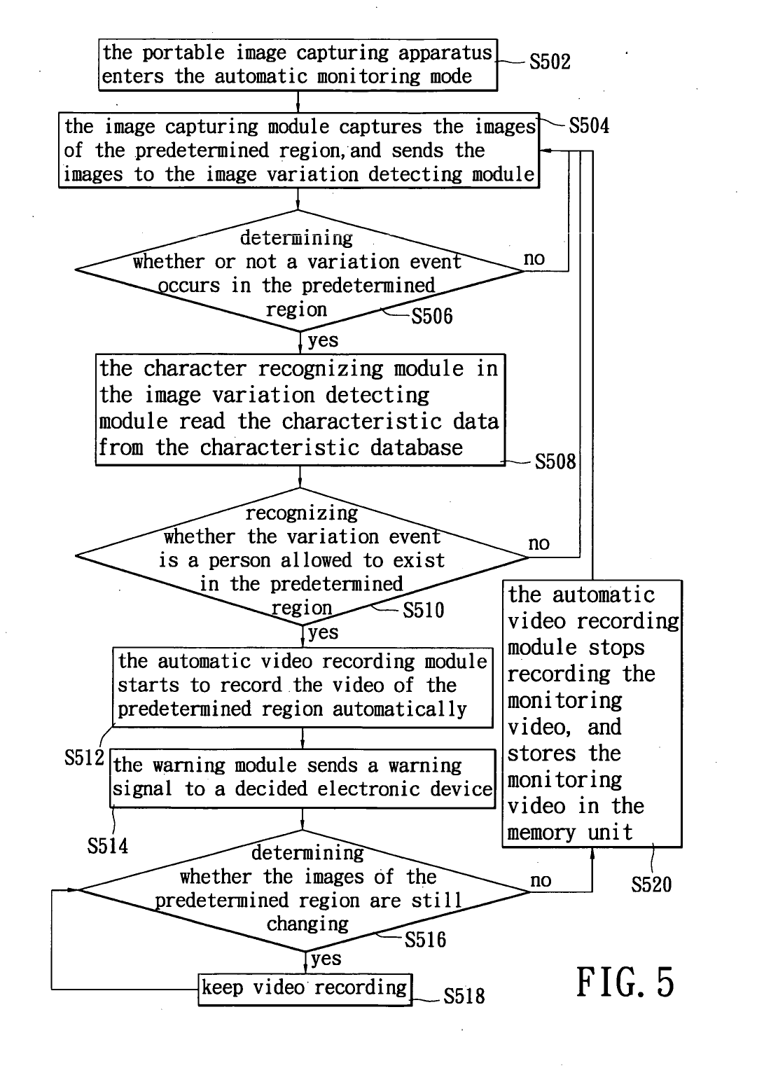

Refer to FIG. 5, which is a flow chart of another embodiment of a method for automatic monitoring of portable image capturing apparatus. In conjunction with FIG. 1, the portable image capturing apparatus enters an automatic monitoring mode in a first step (S502): The image capturing module 101 then captures a plurality of images of the predetermined region and sends the images to image variation detecting module 103 (S504) for further determination.

The image variation detecting module 103 then determines whether or not a variation event occurs in the predetermined region (S506). If the determination result is negative, the step goes back to S504 for continuously capturing the images. If the determination result is positive, the character recognizing module 1033 of the image variation detecting module 103 further reads the characteristic data from the characteristic database 111 (S508), such as the characteristic data of family members, and determines whether the variation event is a person allowed to enter the predetermined region (S510).

If the variation event (a moving person) is the same as one of the characteristic data, that is, the moving person is not a suspicious person, then the portable image capturing apparatus goes back to step S504 for continuously capturing the images of the predetermined region. And if the variation event is different from any of the characteristic data, the automatic video recording module 105 then starts to record the monitoring video of the predetermined region (S512). Additionally, when the monitoring video is recording, the warning module 109 sends a warning signal to a decided electronic device (S514), such as a mobile phone or a computer, for warning users.

Furthermore, the image variation detecting module 103 continuously determines whether the images of the predetermined region are still changing (that is, the variation event is still occurring in the predetermined region) (S516). If the variation event is still occurring, then keep recoding the monitoring video (S518). If the variation event disappears for a period of time, the automatic video recording module 105 then stops the monitoring video recording and stores the monitoring video in the memory unit 107 (S520). Therefore, it achieves the purpose of automatic suspicious person monitoring by using the portable image capturing apparatus.

Besides monitoring the suspicious person, guarding against burglary, and safety assurance, the video monitoring is also used in observation of wild animals or lab experiment, such as observing the activities of an insect or an animal in a day, or observing the phenomena of physical and chemical experiments.

By implementing the aforementioned system and method for automatic monitoring of portable image capturing apparatus, the cost of video monitoring can be reduced, the convenience of video monitoring increases, and the time length of the recorded monitoring video shortened as long as the memory usage decreased. Furthermore, the application field and practical value of video monitoring also increases.

The description above only illustrates specific embodiments and examples of the invention. The invention should cover various modifications and variations made to the structures and operations described herein, and they still fall within the scope of the invention as defined in the following appended claims.

What is claimed is:

1. A method for automatic monitoring of portable image capturing apparatus, and the method is applicable to a portable image capturing apparatus which includes an image capturing module, the method comprises:
capturing a plurality of images in a predetermined region continuously with the image capturing module;
determining whether a variation event occurs in the predetermined region based on the images' observation or not; and
recording a monitoring video in the predetermined region if the variation event occurs.

2. The method for automatic monitoring of portable image capturing apparatus according to claim 1, if the predetermined region is a static region, the step of determining the variation event is to determine whether an object moves in the predetermined region.

3. The method for automatic monitoring of portable image capturing apparatus according to claim 1, wherein the step of determining the variation event comprises a step of determining whether the variation event is a person allowed to enter the predetermined region or not.

4. The method for automatic monitoring of portable image capturing apparatus according to claim 1, wherein the step of determining whether or not the variation event occurs in the predetermined region is a continuous work; and if the variation event disappears for a period of time, the portable image capturing apparatus stops recording the monitoring video, and stores the monitoring video.

5. The method for automatic monitoring of portable image capturing apparatus according to claim 1, further comprises a step of sending a warning signal to an electronic device when the method starts to record the video.

6. The method for automatic monitoring of portable image capturing apparatus according to claim 5, wherein the warning signal is sent by wired transmission or wireless transmission.

7. A system for automatic monitoring of portable image capturing apparatus, and the portable image capturing apparatus includes at least one image capturing module for monitoring a predetermined region continuously, the automatic monitoring system comprises:
an image variation detecting module, for detecting a variation event which occurs in the predetermined region; and
an automatic video recording module, for recording a monitoring video in the predetermined region automatically when the image variation detecting module detects the variation event occurring in the predetermined region.

8. The system for automatic monitoring of portable image capturing apparatus according to claim 7, wherein the image variation detecting module includes a motion detecting module, for detecting an event of an object moves in the predetermined region.

9. The system for automatic monitoring of portable image capturing apparatus according to claim 7, wherein the image variation detecting module includes a character recognizing module, which is coupled with a characteristic database in the portable image capturing apparatus, for recognizing a person moving in the predetermined region; when the character recognizing module detects that the person does not exist in the characteristic database, the automatic video recording module is triggered to record the monitoring video.

10. The system for automatic monitoring of portable image capturing apparatus according to claim 7, wherein the image variation detecting module continuously detects the variation event in the predetermined region; and if the variation event disappears for a period of time, the automatic video recording module then stops recording the monitoring video in the predetermined region and stores the monitoring video.

11. The system for automatic monitoring of portable image capturing apparatus according to claim 7, further comprises a warning module, which is coupled with the automatic video recording module and connects to an external network, for sending a warning signal to an electronic device when the automatic video recording module starts to record the monitoring video.

12. The system for automatic monitoring of portable image capturing apparatus according to claim 11, wherein the external network is a wired network or a wireless network.

13. The system for automatic monitoring of portable image capturing apparatus according to claim 11, wherein the electronic device is a mobile phone, a computer, or a personal digital assistant.

14. The system for automatic monitoring of portable image capturing apparatus according to claim 7, wherein the image capturing module comprises an optical image capturing component and an image sensor.
